(19) United States
(12) Patent Application Publication
(10) Pub. No.: US 2025/0293285 A1
(43) Pub. Date: Sep. 18, 2025

(54) SOLID-STATE BATTERY AND METHOD FOR PRODUCING SOLID-STATE BATTERY

(71) Applicant: TOYOTA JIDOSHA KABUSHIKI KAISHA, Toyota-shi (JP)

(72) Inventors: Kento MASUMURA, Nagakute-shi (JP); Masatsugu KAWAKAMI, Sunto-gun (JP)

(73) Assignee: TOYOTA JIDOSHA KABUSHIKI KAISHA, Toyota-shi (JP)

(21) Appl. No.: 19/069,335

(22) Filed: Mar. 4, 2025

(30) Foreign Application Priority Data
Mar. 13, 2024 (JP) 2024-039003

(51) Int. Cl. H01M 10/04; H01M 10/0585; H01M 50/414

(52) U.S. Cl. CPC H01M 10/0468; H01M 10/0585; H01M 50/414

(57) ABSTRACT

A main object of the present disclosure is to provide a solid-state battery in which an increase in battery resistance caused by peeling of an electrode layer is suppressed. The present disclosure achieves the object by providing a solid-state battery comprising: a cathode current collector; a first cathode active material layer, a first solid electrolyte layer, a first anode active material layer and a first anode current collector that are laminated in this order from a first surface of the cathode current collector; and a second cathode active material layer, a second solid electrolyte layer, a second anode active material layer and a second anode current collector that are laminated in this order from a second surface opposed to the first surface of the cathode current collector, wherein each of the cathode current collector, the first anode current collector and the second anode current collector is a metal current collector, and a resin layer is disposed at least either between the first anode active material layer and the first anode current collector or between the second anode active material layer and the second anode current collector.

### TECHNICAL FIELD

The present disclosure relates to a solid-state battery and method for producing a solid-state battery.

### BACKGROUND ART

In recent years, with the rapid spread of electronic devices such as personal computers and mobile phones, a battery used as a power source thereof has been developed. Also, the automotive industry is developing battery for use in hybrid electric vehicle (HEV), plug-in hybrid electric vehicle (PHEV), or battery electric vehicle (BEV).

For example, Patent Literature 1 discloses a current collector for a bipolar secondary battery, which is composed of layers of a crystalline resin having a melting point of 120° C. or higher and a conductive material.

### CITATION LIST

### Patent Literatures

Patent Literature 1: Japanese Patent Application Laid-Open (JP-A) No. 2010-170833

### SUMMARY OF DISCLOSURE

### Technical Problem

Battery using solid electrolyte as an electrolyte is commonly referred to as a solid-state battery. In the solid-state battery, the electrode layers (a cathode active material layer and an anode active material layer) may expand and contract as battery is charged and discharged, so that the electrode layers may be peeled off from current collector and battery resistance may be increased.

The present disclosure has been made in view of the above circumstances, and a main object of the present disclosure is to provide a solid-state battery in which an increased battery resistance caused by peeling of an electrode layer is suppressed.

### Solution to Problem

[1]

A solid-state battery comprising:
a cathode current collector;
a first cathode active material layer, a first solid electrolyte layer, a first anode active material layer and a first anode current collector that are laminated in this order from a first surface of the cathode current collector; and
a second cathode active material layer, a second solid electrolyte layer, a second anode active material layer and a second anode current collector that are laminated in this order from a second surface opposed to the first surface of the cathode current collector, wherein
each of the cathode current collector, the first anode current collector and the second anode current collector is a metal current collector, and
a resin layer is disposed at least either between the first anode active material layer and the first anode current collector or between the second anode active material layer and the second anode current collector.
   [2]

A method for producing a solid-state battery, the method comprising:
a preparing step of preparing a layered body including a cathode active material layer, a solid electrolyte layer and an anode active material layer, and, a current collecting material including a metal current collector and a resin layer;
a first pressing step of densifying the layered body by pressing; and
a second pressing step of attaching the resin layer to at least either the cathode active material layer or the anode active material layer by placing the layered body upon the current collecting material and applying a heat pressing, after the first pressing step, wherein
a press pressure in the second pressing step is smaller than that of the first pressing step.
   [3]

The method for producing a solid-state battery according to [2], wherein the press pressure (linear pressure) in the first pressing step is 40 kN/cm or more, and the press pressure (linear pressure) in the second pressing step is 5 kN/cm or less.

[4]

The method for producing a solid-state battery according to [2] or [3], wherein the resin layer contains a thermoplastic resin and a conductive material, and a softening temperature of the thermoplastic resin is 170° C. or less.

[5]

The method for producing a solid-state battery according to any one of [2] to [4], wherein the layered body comprises:
a cathode current collector;
a first cathode active material layer, a first solid electrolyte layer and a first anode active material layer that are laminated in this order from a first surface of the cathode current collector; and
a second cathode active material layer, a second solid electrolyte layer and a second anode active material layer that are laminated in this order from a second surface opposed to the first surface of the cathode current collector,
wherein the metal current collector in the current collecting material is an anode current collector; and
wherein the resin layer is attached to the first anode active material layer and the second anode active material layer in the second pressing step.

### Advantageous Effects of Disclosure

According to the present disclosure, it is possible to provide a solid-state battery in which an increase in battery resistance caused by peeling of an electrode layer is suppressed.

### BRIEF DESCRIPTION OF DRAWINGS

FIG. 1 is a schematic cross-sectional view illustrating the solid-state battery in the present disclosure.

FIGS. 2A to 2E are schematic cross-sectional views illustrating the layered body prepared by the preparing step.

FIG. 3 is a schematic cross-sectional view illustrating the layered body prepared by the preparing step.

FIG. 4 is a schematic cross-sectional view illustrating the current collecting material prepared by a preparing step.

FIG. 5 is a flowchart illustrating the method for producing of the solid-state battery according to reference example 1.

FIG. 6 is a flowchart illustrating the method for producing of the solid-state battery according to reference example 2.

### DESCRIPTION OF EMBODIMENTS

Hereinafter, method for producing of the solid battery and the solid battery will be described. Each of the drawings shown below is schematically shown, and the size and shape of each part are appropriately exaggerated for ease of understanding. Here, for example, when simply referred to as a cathode active material layer, both the first cathode active material layer and the second cathode active material layer are referred to in this specification.

The same applies to anode active material layers, solid electrolyte layers, and anode current collector.

### A. Solid-State Battery

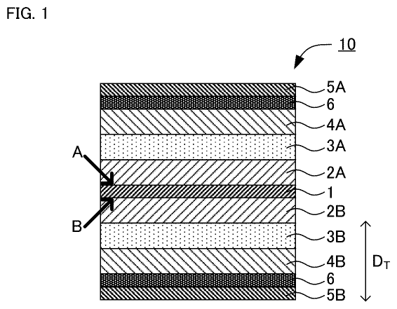

FIG. 1 is a schematic cross-sectional view illustrating a solid-state battery according to the present disclosure. The solid-state battery 10 shown in FIG. 1 includes a cathode current collector 1, are stacked in this order from the first surface A of cathode current collector 1, the first cathode active material layer 2A, the first solid electrolyte layer 3A, the first anode active material layer 4A and the first anode current collector 5A, are stacked in this order from the second surface B of cathode current collector 1 facing the first surface A, the second cathode active material layer 2B, the second solid electrolyte layer 3B, and a second anode active material layer 4B and the second anode current collector 5B. In the solid-state battery 10, cathode current collector 1, the first anode current collector 5A, and the second anode current collector 5B are metallic current collector. Further, in the solid-state battery 10, the resin layer 6 is disposed between the first anode active material layer 4A and the first anode current collector 5A, and between the second anode active material layer 4B and the second anode current collector 5B.

In the solid-state battery according to the present disclosure, a resin layer is disposed between at least one of the first anode active material layer and the first anode current collector and between the second anode active material layer and the second anode current collector. It is believed that the resin contained in the resin layer improves the adhesiveness between anode active material layer and anode current collector. That is, it is considered that the resin layer functions as an adhesive layer. As a consequence, it is considered that battery resistivity is suppressed from increasing due to the peeling of anode active material layers.

### 1. Resin Layer

The resin layer is a layer disposed between at least one of the first anode active material layer and the first anode current collector, which will be described later, and between the second anode active material layer and the second anode current collector. The resinous layer may be disposed only between the first anode active material layer and the first anode current collector, may be disposed only between the second anode active material layer and the second anode current collector, or may be disposed both.

The resin layer usually contains a resin. Examples of the resin include thermoplastic resins such as polypropylene, polyethylene, polyvinyl chloride, polystyrene, acrylonitrile butadiene styrene (ABS) resin, methacrylic resin, polyamide, polyester, polycarbonate, and polyacetal. Further, the softening temperature of the resin (softening point) is not limited in particular, for example 170° C. or less, may be 150° C. or less, may be 130° C. or less, 100° C. or less. On the other hand, the softening point of the resin is, for example, 60° C. or higher.

The ratio of the resin in the resin layer is, for example, 50 wt % or more and 95 wt % or less.

The resin layer generally contains a conductive material in order to impart conductivity. Examples of the conductive material include a carbon material. Examples of the carbon material include particulate carbon materials such as acetylene black (AB) and Ketjen black (KB); and fibrous carbon materials such as carbon fibers, carbon nanotubes (CNT), and carbon nanofibers (CNF). The proportion of the conductive material in the resin layer is, for example, 5 wt % or more and 50 wt % or less.

The resin layer may contain, for example, a filler such as an inorganic filler. Examples of the inorganic filler include metal oxides such as alumina, zirconia, and silica, and metal nitrides such as silicon nitride. When the resin layer contains a filler, deformation of the resin layer can be suppressed. The proportion of the filler in the resin layer is, for example, 5 wt % or more and 50 wt % or less.

The thickness of the resin layer is not particularly limited, but is, for example, 1 μm or more and 500 μm or less.

### 2. Cathode Current Collector

Cathode current collector is a member that collects electrons in cathode active material layers (first cathode active material layers and second cathode active material layers) described later. In addition, cathode current collector in the present disclosure is a metallic current collector.

Examples of cathode current collector (metallic current collector) include SUS, aluminum, nickel, and carbon. Examples of the form of cathode current collector include a foil form. The thickness of cathode current collector is, for example, 1 μm or more and 500 μm or less.

As shown in FIG. 1, cathode current collector 1 has a first surface A and a second surface B opposed to the first surface A in the thickness-direction Dr.

### 3. First Cathode Active Material Layer and Second Cathode Active Material Layer

The first cathode active material layer is a member disposed on the first surface of cathode current collector, and the second cathode active material layer is a member disposed on the second surface of cathode current collector.

Cathode active material layers contain at least cathode active material. Examples of the cathode active material may include an oxide active material. Examples of the oxide active material include a rock salt layered active material such as LiCoO₂, LiNi_{1/3}CO_{1/3}Mn_{1/3}O₂, a spinel-type active material such as LiMn₂O₄, Li₄Ti₅O₁₂, and an olivine-type active material such as LiFePO₄. The form of cathode active material is, for example, particulate.

Cathode active material layers may further contain at least one of a conductive material, a binder, and an electrolyte. Conductive material is the same as described in “1. Resin layer”. Examples of the binder may include rubber-based binders such as butylene rubber (BR) and styrene butadiene rubber (SBR); and fluoride-based binders such as polyvinylidene fluoride (PVDF). The electrolyte is the same as described in “4. First solid electrolyte layer and second solid electrolyte layer”. The thickness of cathode active material layers is, for example, 0.1 μm or more and 1000 μm or less.

### 4. First Solid Electrolyte Layer and Second Solid Electrolyte Layer

The first solid electrolyte layer and the second solid electrolyte layer contain at least solid electrolyte, and are members disposed on the first surface side and the second surface side of cathode current collector, respectively.

Examples of solid electrolyte include mineral solid electrolyte such as sulfide solid electrolyte, oxide solid electrolyte, and halide solid electrolyte. Sulfide solid electrolyte preferably contains sulphur(S) as a main component of the anionic element. The oxide solid electrolyte preferably contains oxygen (O) as a main component of the anionic element. The halide solid electrolyte preferably contains a halogen as a main component of the anionic. Of these, sulfide solid electrolyte is preferred.

Other exemplary solid electrolyte includes organic solid electrolyte such as polymeric electrolytes, gel-electrolytes, and the like. Solid electrolyte layers may contain a liquid-electrolyte (electrolyte solution) as an electrolyte. The thickness of solid electrolyte layers is, for example, 1 μm or more and 500 μm or less.

### 5. First Anode Active Material Layer and Second Anode Active Material Layer

The first anode active material layer and the second anode active material layer contain at least anode active material, and are members disposed on the first surface side and the second surface side of cathode current collector, respectively.

Examples of anode active material include a metal-active material such as Li, Sn, a Si active material, a carbon-active material such as graphite, and an oxide-active material such as Li₄Ti₅O₁₂. Among them, a Si active material is preferable. This is because it is possible to increase the capacitance of battery.

Anode active material layers may further contain at least one of a conductive material, a binder, and an electrolyte. These are similar to those described in “3. Tiers 1 cathode active material and 2 cathode active material.” The thickness of anode active material layers is, for example, 0.1 μm or more and 1000 μm or less.

### 6. First Anode Current Collector and Second Anode Current Collector

The first anode current collector and the second anode current collector are members that collect electronics of the first anode active material layer and the second anode active material layer, respectively. In addition, the first anode current collector and the second anode current collector are metallic current collector.

Examples of anode current collector (metallic current collector) include SUS, copper, and nickel. Examples of the form of anode current collector include a foil form. The thickness of anode current collector is, for example, 1 μm or more and 500 μm or less.

### 7. Solid-State Battery

The solid-state battery according to the present disclosure may include an exterior body for accommodating the above-described member. Examples of exterior body include a case-type exterior body and a laminated-type exterior body. The solid-state battery may include a restraining tool that applies a restraining pressure to the above-described member in the thickness direction. As the restraining jig, a known jig can be used. The constraining pressure may be, for example, greater than or equal to 0.1 MPa and less than or equal to 50 MPa, and greater than or equal to 1 MPa and less than or equal to 20 MPa.

The above-described solid-state battery is a so-called monopolar battery having two sets of cathode active material layers, solid electrolyte layers, and anode active material layers (power generation units). In addition, the solid-state battery is typically a lithium-ion secondary battery. Further, the solid battery in the present disclosure may be a semi-solid battery or may be an all-solid-state battery. Generally, a solid-state battery in which all of the electrolytes constituting solid electrolyte layers are made of inorganic solid electrolyte is referred to as all solid-state battery.

Applications of the solid-state battery in the present disclosure are not particularly limited, and examples thereof include power supplies of vehicles such as hybrid electric vehicle (HEV), plug-in hybrid electric vehicle (PHEV), battery electric vehicle (BEV), gasoline-powered vehicles, and diesel-powered vehicles. In particular, it is preferably used for a power supply for driving a hybrid electric vehicle (HEV), a plug-in hybrid electric vehicle (PHEV), or a battery electric vehicle (BEV). In addition, the solid-state battery may be used as a power source for a moving object (for example, a railroad, a ship, or an airplane) other than vehicles, or may be used as a power source for an electric appliance such as an information processing device.

The solid battery according to the present disclosure is preferably produced, for example, by the method described in “method for producing of B. solid battery” described later.

### B. Method for Producing Solid-State Battery

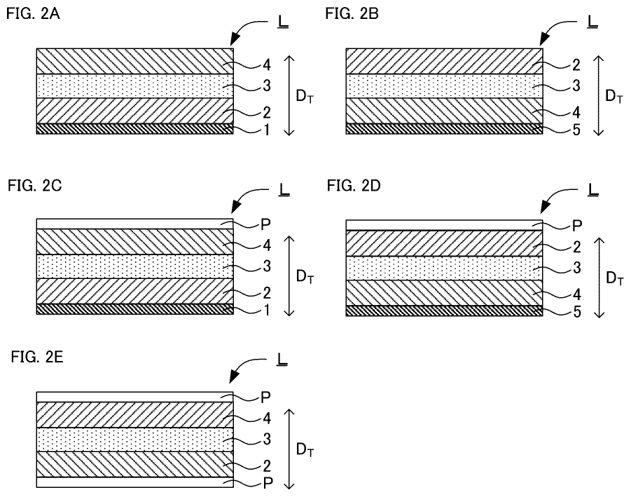

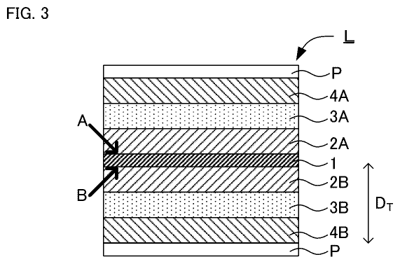

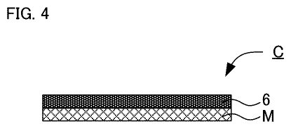

FIG. 3 is a schematic cross-sectional view illustrating a layered product prepared in a method for producing of a solid-state battery according to the present disclosure. FIG. 4 is a schematic cross-sectional view illustrating a current collecting member prepared in method for producing of the solid-state battery according to the present disclosure. In method for producing of the solid-state battery in the present disclosure, as shown in FIGS. 2 and 3, a current collector member C having a metal current collector M and a resin layer 6 as shown in FIG. 4 is prepared (preparing step) with a cathode active material layer 2 (2A, 2B), a solid electrolyte layer 3 (3A, 3B), and a anode active material layer 4 (4A, 4B) layered product L. Next, layered product L is pressed to be densified (first pressing step). Then, after the first pressing step, layered product L and the current collector member C are superposed and heated and pressed, whereby the resinous layer 6 is attached to at least one of cathode active material layer 2 and anode active material layer 4 (second pressing step). In particular, in method for producing of the solid-state battery according to the present disclosure, the pressing pressure in the second pressing step is smaller than the pressing pressure in the first pressing step.

A solid battery including the resin-layer as described above can be manufactured by method for producing of the solid battery in the present disclosure.

Here, when a solid battery is manufactured, it is assumed that a pressing pressure is applied in order to densify the respective layers constituting the solid battery. Further, for densification, it is assumed that a relatively large pressing pressure is applied. On the other hand, the resin layer is easily deformed by press pressure and easily stretched. Further, if the electrode layer is deformed following the elongation of the resin layer, the electrode layer may be cracked. On the other hand, in method for producing of the solid-state battery according to the present disclosure, layered product having no resin layer is pressed to densify cathode active material layer and the like, and then the resin layer is adhered thereto, so that a large pressing pressure is not applied to the resin layer. As a consequence, deformation (elongation) of the resin layer in the manufacturing process of the solid battery can be suppressed, and cracking of the electrode layer can be suppressed, whereby a solid battery (solid battery having a resin layer) can be manufactured.

### 1. Preparing Step

Preparing step in the present disclosure is a step of preparing a predetermined layered body and a current collecting member.

### (1) Layered Body

Layered body has cathode active material layers, solid electrolyte layers, and anode active material layers. The details of cathode active material layers, solid electrolyte layers, and anode active material layers are the same as those described in “A. Solid-state battery”.

Cathode active material layer, solid electrolyte layer, and anode active material layer can be formed by a slurry-based coating method. As the coating method, the method described in the reference example described later can be exemplified. As a method of laminating the layers, for example, a method using a transfer member as described in a reference example to be described later can be cited.

As shown in FIG. 2A and FIG. 2B, layered product L may have one of cathode current collector 1 and anode current collector 5. In this case, a resinous layer to be described later is attached to the electrode layer (anode active material layer 4 or cathode active material layer 2) having no current collector. Further, when the layers are laminated by using the transfer member, as shown in FIGS. 2(c), (d) and (e), layered product L may have a substrate P on at least one surface of the electrode layer (cathode active material layer 2, anode active material layer 4) located at the end in the thickness Dr.

Here, in layered product, cathode active material layer, solid electrolyte layer, and anode active material layer may be disposed only on one surface side of current collector in the thickness direction (FIG. 2) or may be disposed on both surfaces side thereof (FIG. 3). For example, layered product L in FIG. 3 includes a cathode current collector 1, a second cathode current collector layer 2B, a second cathode active material layer 2A, and a second solid electrolyte layer 3A, which are stacked in this order from the first surface A of cathode current collector 1, which are stacked in this order from the second surface B of cathode current collector 1 facing the first surface A, and a first anode active material layer 4B and a first anode active material layer 4A. Also in such a layered product L, a substrate P may be disposed on at least one of the terminal electrode layers (anode active material layer 4) in the thickness Dr. Here, layered product L shown in FIG. 3 is a so-called monopolar type, but may be a bipolar type.

### (2) Current Collector

As shown in FIG. 4, the current collector member C includes a metallic current collector M and a resinous layer 6. The resinous layers are the same as those described in “A. Solid battery”. The current collector member may be a cathode member or a anode member. That is, the metallic current collector may be cathode current collector or anode current collector. Cathode current collector and anode current collector are the same as described in “A. Solid-state battery”.

The current collector may be prepared by applying a resin slurry including at least a resin to a metallic current collector and drying the resin slurry. Note that the current collector member may be prepared before the first pressing step described later, or may be prepared after the first pressing step and before the second pressing step.

### 2. First Pressing Step

The first pressing step is a step of pressing and densifying layered product.

The pressing method in the first pressing step is not particularly limited, and examples thereof include a roll press and a flat plate press. The pressing pressure (linear pressure, surface pressure) in the first pressing step is not particularly limited as long as layered product can be densified and is larger than the pressing pressure in the second pressing step described later. The linear pressure is, for example, equal to or higher than 40 kN/cm, and may be equal to or higher than 50 kN/cm. On the other hand, the linear pressure may be, for example, less than or equal to 100 kN/cm and less than or equal to 80 kN/cm. Further, the surface pressure in the plate press is, for example, 10 kN/cm² or more, and may be 30 kN/cm² or more. On the other hand, the surface pressure may be, for example, equal to or less than 70 kN/cm² and equal to or less than 50 kN/cm². The pressing may be performed at a normal temperature (for example, 25° C.) or while layered product is heated. The heating temperature is, for example, 60° C. or higher and 170° C. or lower.

### 3. Second Pressing Step

The second pressing step is a step of applying the resin layer to at least one of cathode active material layer and anode active material layer by heating and pressing layered product and the current collector member after the first pressing step. In particular, the pressing pressure in the second pressing step is smaller than the pressing pressure in the first pressing step. When layered product includes a substrate, the substrate is removed prior to the second pressing step.

In the second pressing step, a resin layer may be attached to cathode active material layer, and a resin layer may be attached to anode active material layer. When layered product has a anode active material layer at each end in the thickness direction, a resin layer may be attached to one side or a resin layer may be attached to both sides.

The pressing method in the second pressing step is not particularly limited as long as it is a hot press, and examples thereof include a roll press and a flat plate press. The pressing pressure (linear pressure, surface pressure) in the second pressing step is not particularly limited as long as the resin layer can be attached to the electrode layer and is smaller than the pressing pressure in the first pressing step. The linear pressure may be, for example, equal to or less than 5.0 kN/cm, equal to or less than 4.0 kN/cm, or equal to or less than 2.5 kN/cm. On the other hand, the linear pressure is, for example, 1.0 kN/cm or more. The surface pressure is, for example, 8 kN/cm² or less, 1 kN/cm² or more.

The heating temperature in the hot press is preferably equal to or higher than the softening point of the resin in the resin layer. This is because the adhesiveness of the resin layer can be improved. The heating temperature is, for example, 60° C. or higher, may be 80° C. or higher, or may be 100° C. or higher. On the other hand, the heating temperature is, for example, 170° C. or less, may be 150° C. or less, or may be 130° C. or less.

### 4. Solid-State Battery

The solid-state battery produced by the process described above may be a battery having two power generation units. Here, the solid battery may be a monopolar battery or a bipolar A. as shown in “Solid battery”. In addition, the solid-state battery to be produced may be a battery having one of the above-described power generation units.

In addition, the components and descriptions of the solid battery are the same as those described in A. solid battery.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Reference Example 1

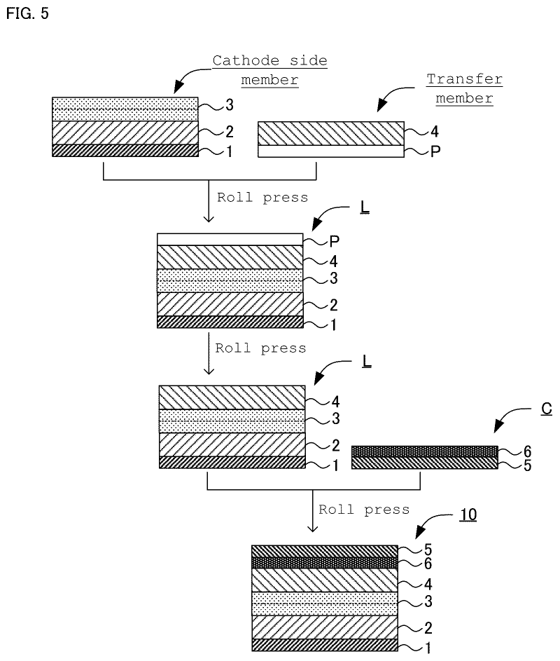

As shown in FIG. 5, densification pressing was performed on layered product L having no resin-layer (first pressing step), and then a current collector member was attached (second pressing step) to produce a solid-state battery.

### (Prepare of Current Collector Member)

A current collector member C having a metal current collector (anode current collector 5) and a resin layer 6 disposed on one surface of the metal current collector in the thickness direction was prepared in the following manner.

First, a vinyl resin (thermoplastic resin) and carbon (conductive material) were mixed at a weight ratio of 80:20 to prepare a resin slurry. The softening point of the vinyl resin used was 68° C. The resin slurry was applied by a blade method onto a nickel foil (anode current collector) and dried on a hot plate at 80° C. for 30 minutes. Thereafter, the mixture was dried on a hot plate at 170° C. for 30 minutes. Thus, a current collector member was prepared.

### (Preparing Layered Body)

A slurry containing cathode active material (NCA:LiNi_{0.8}Co_{0.15}Al_{0.05}O₂), sulfide based solid electrolyte (SE:Li₂S—P₂S₅), vapor deposited carbon fiber (VGCF), polyvinylidene fluoride (PVdF) based binder, and butyl butyrate was stirred in an ultrasonic dispersing device to obtain a cathode slurry. NCA, SE, VGCF and PVdF based binders were 78.3:18.8:1.6:1.4 by weight. Cathode slurry was applied by a blade method onto a Al foil (cathode current collector) and dried on a hot plate at 50° C. for 30 minutes. Thereafter, the mixture was dried on a hot plate at 170° C. for 30 minutes. This gave a cathode with cathode active material layers 2 and cathode current collector 1.

Next, a slurry containing sulfide based solid electrolyte (SE:Li₂S—P₂S₅), acrylonitrile butadiene rubber (ABR) based binder, heptane, and butyl butyrate was stirred by an ultrasonic dispersing device to obtain a SE slurry. Here, the weight-ratio of SE to ABR binder was set to 99.4:0.6. SE slurry was applied by a blade method onto cathode active material layers and dried on a hot plate at 50° C. for 1 minute. Thereafter, the mixture was dried on a hot plate at 150° C. for 30 minutes to obtain a solid electrolyte layer (SE layer). On SE layer, another one-layer SE layer was formed in the same manner. As a result, a cathode member having cathode current collector 1, cathode active material layer 2, and solid electrolyte layer 3 was obtained.

Next, a slurry containing anode active material (silicone: Si), sulfide based solid electrolyte (SE:Li₂S—P₂S₅), vapor deposited carbon fiber (VGCF), polyvinylidene fluoride (PVdF) based binder, and butyl butyrate was stirred by an ultrasonic dispersing device to obtain a anode slurry. Here, the weight-ratio of Si, SE, VGCF and PVdF binder was adjusted to be 49.3:41.5:6.4:2.8. Anode slurry was applied by a blade method onto substrate (stainless steel (SUS) foil) and dried on a 50° C. hot plate for 30 minutes. Then, it was dried on a hot plate at 170° C. for 30 minutes. As a result, a transfer member having anode active material layers 4 and substrate P was obtained.

Cathode member and the transfer member were stacked so that solid electrolyte layer and anode active material layer were opposed to each other. This gave a layered product L with cathode current collector 1, cathode active material layer 2, solid electrolyte layer 3 and anode active material layer 4 and substrate P.

(Preparation of all-Solid-State Battery)

Layered product L was roll-pressed at 165° C. under 50 kN/cm, and substrate (SUS foil) was peeled off (first pressing step). Then, layered product L and the current collector member C were arranged so that anode active material layer 4 and the resin layer 6 were opposed to each other, and layered product L and the current collector member C were roll-pressed at 165° C. and 2.5 kN/cm (second pressing step). This gave all-solid-state battery 10 with resinous layer 6 disposed between anode active material layer 4 and anode current collector 5.

### Reference Example 2

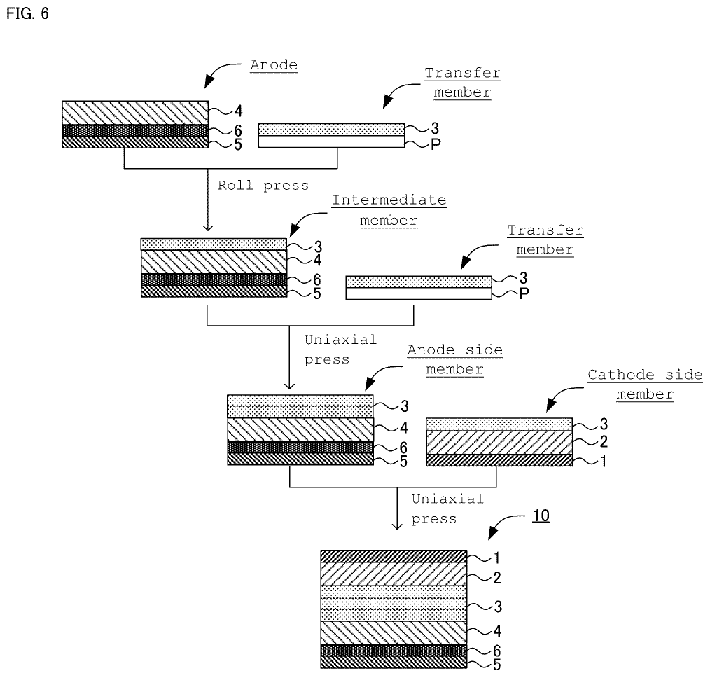

As shown in FIG. 6, a layered product L having a resinous layer 6 was subjected to a densification press a plurality of times to prepare a solid-state battery.

First, a current collector member C having a plastic layer 6 and a metallic current collector (anode current collector 5) was prepared in the same manner as in Reference 1. Next, a slurry containing anode active material (silicone: Si), sulfide based solid electrolyte (SE:Li₂S—P₂S₅), vapor deposited carbon fiber (VGCF), polyvinylidene fluoride (PVdF) based binder, and butyl butyrate was stirred by an ultrasonic dispersing device to obtain a anode slurry. The weight-ratio of Si, SE, VGCF and PVdF based binders was 49.3:41.5:6.4:2.8. Anode slurry was applied by a blade method onto the resin-layer of the current collector, and dried on a hot plate at 50° C. for 30 minutes. Thereafter, the mixture was dried on a hot plate at 170° C. for 30 minutes. This gave a anode having a anode active material layer 4, a resinous layer 6 and a anode current collector 5.

A SE slurry was prepared in the same manner as in Reference 1. SE slurry was applied to a substrate (Al foil) by a blade method and dried. Thus, a transfer member having solid electrolyte layers 3 and substrate P was prepared.

Anode and the transfer member were stacked so that anode active material layers and solid electrolyte layers were opposed to each other, sandwiched between SUS foils, and roll-pressed at 25° C. under 30 kN/cm. Thereafter, Al foil was peeled off. As a result, an intermediate member having anode current collector 5, the resinous layer 6, anode active material layer 4, and solid electrolyte layer 3 was obtained.

Next, a transfer member having solid electrolyte layer 3 (bonding SE layer) and substrate P was prepared in the same manner as described above, except that substrate was changed to SUS foil. A cathode side member was prepared in the same manner as in Reference 1 except that the number of solid electrolyte layers was changed to one.

The intermediate member and the transfer member were stacked so that solid electrolyte layers were opposed to each other, and uniaxial pressing (densification pressing) was performed at 25° C. and 19 kN/cm² to obtain an anode member. Then, anode side member and cathode side member were stacked so that solid electrolyte layers were opposed to each other, and uniaxial pressing was performed at 160° C. and 50 kN/cm². This gave an all-solid-state battery.

### [Evaluation]

Whether or not cracks occurred in anode active material layers of all solid-state battery prepared in Reference Examples 1 and 2 was visually confirmed. The results are shown in Table 1. As shown in Table 1, there was no cracking of the electrode in Reference Example 1.

TABLE 1

| | Presence or absence of cracks |
|---|---|
| Reference Ex. 2 | Presence |
| Reference Ex. 1 | Absence |

In both of all solid-state battery prepared in Reference Examples 1 and 2, it is considered that the peeling of anode active material layer from anode current collector is suppressed because the resinous layer is disposed between anode active material layer and anode current collector, and it is considered that the increased battery resistivity caused by the peeling of anode active material layer is suppressed. On the other hand, as shown in Reference 1, if battery of the solid method for producing in the present disclosure, it is possible to suppress the cracking of the electrode-layer during manufacturing, battery of the solid battery It was suggested that can be lowered themselves.

### REFERENCE SINGS LIST

1 cathode current collector
2A first cathode active material layer
2B second cathode active material layer
3A first solid electrolyte layer
3B second solid electrolyte layer
4A first anode active material layer
4B second anode active material layer
5A first anode current collector
5B second anode current collector
6 resin layer
10 solid-state battery

What is claimed is:

1. A solid-state battery comprising:
a cathode current collector;
a first cathode active material layer, a first solid electrolyte layer, a first anode active material layer and a first anode current collector that are laminated in this order from a first surface of the cathode current collector; and
a second cathode active material layer, a second solid electrolyte layer, a second anode active material layer and a second anode current collector that are laminated in this order from a second surface opposed to the first surface of the cathode current collector, wherein
each of the cathode current collector, the first anode current collector and the second anode current collector is a metal current collector, and
a resin layer is disposed at least either between the first anode active material layer and the first anode current collector or between the second anode active material layer and the second anode current collector.

2. A method for producing a solid-state battery, the method comprising:
a preparing step of preparing a layered body including a cathode active material layer, a solid electrolyte layer and an anode active material layer, and, a current collecting material including a metal current collector and a resin layer;
a first pressing step of densifying the layered body by pressing; and
a second pressing step of attaching the resin layer to at least either the cathode active material layer or the anode active material layer by placing the layered body upon the current collecting material and applying a heat pressing, after the first pressing step, wherein
a press pressure in the second pressing step is smaller than that of the first pressing step.

3. The method for producing a solid-state battery according to claim 2, wherein the press pressure (linear pressure) in the first pressing step is 40 kN/cm or more, and the press pressure (linear pressure) in the second pressing step is 5 kN/cm or less.

4. The method for producing a solid-state battery according to claim 2, wherein the resin layer contains a thermoplastic resin and a conductive material, and a softening temperature of the thermoplastic resin is 170° C. or less.

5. The method for producing a solid-state battery according to claim 2, wherein the layered body comprises:
a cathode current collector;
a first cathode active material layer, a first solid electrolyte layer and a first anode active material layer that are laminated in this order from a first surface of the cathode current collector; and
a second cathode active material layer, a second solid electrolyte layer and a second anode active material layer that are laminated in this order from a second surface opposed to the first surface of the cathode current collector,
wherein the metal current collector in the current collecting material is an anode current collector; and
wherein the resin layer is attached to the first anode active material layer and the second anode active material layer in the second pressing step.
